(19) United States
(12) Patent Application Publication
(10) Pub. No.: US 2024/0402536 A1
(43) Pub. Date: Dec. 5, 2024

(54) RUBBER FRAME, BACKLIGHT MODULE AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Xuefeng Ding, Beijing (CN); Tianma Li, Beijing (CN); Liang Li, Beijing (CN); Dake Wang, Beijing (CN); Wenzhu Zeng, Beijing (CN); Zilian Xiong, Beijing (CN); Jingtao Zhu, Beijing (CN); Tao Xi, Beijing (CN)

(73) Assignees: CHENGDU BOE OPTOELECTRONICS TECHNOLOGY CO., LTD., Chengdu, Sichuan (CN); BOE TECHNOLOGY GROUP CO., LTD., Beijing (CN)

(21) Appl. No.: 18/273,364

(22) PCT Filed: May 30, 2022
(86) PCT No.: PCT/CN2022/095951

§ 371 Date: Jul. 20, 2023

(51) Int. Cl. G02F 1/13357; G02F 1/1335

(52) U.S. Cl. CPC G02F 1/133608; G02F 1/133612

(57) ABSTRACT

The present disclosure provides a rubber frame for supporting a display panel. A flexible printed circuit board is coupled to a binding end of the display panel, the rubber frame includes an annular frame body, the annular frame body includes a first portion corresponding to the flexible printed circuit board, and the first portion is separated from the other portions of the annular frame body. The present disclosure further provides a backlight module and a display device.

### TECHNICAL FIELD

The present disclosure relates to the manufacture of a display product, in particular to a rubber frame, a backlight module, and a display device.

### BACKGROUND

Considering that a Flexible Printed Circuit (FPC) needs to be bent at a Display Port (DP) side (binding side), the FPC is fixed onto a back plate of a backlight module. In order to prevent the assembling from being adversely affected due to the interference of an FPC bending region with a rubber frame, and prevent the occurrence of COG mura (an uneven visual effect caused by a difference in pixels in a local region at a position in a liquid crystal display adjacent to a driving chip) due to a stress generated when the FPC is in contact with the rubber frame, as a conventional backlight design, the rubber frame at the DP side is directly provided with an avoidance structure. However, in some schemes, in order to fix the entire machine to the module in a better manner, the rubber frame is of a one-piece structure, leading to many drawbacks during the assembling. For example, the FPC is in direct contact with the rubber frame at the DP side at a position where the FPC is bent, so the COG mura occurs due to the generated stress. In order to prevent the FPC to be in contact with the rubber frame, a longer FPC needs to be provided, leading to a remarkable increase in the manufacture cost as well as low operability. For another example, when a cover plate needs to be attached, it is impossible to attach the cover plate and then perform the assembling, i.e., the assembling is performed before the attachment, and at this time, a serious problem of L0 light leakage occurs for the product. Due to the above-mentioned drawbacks, the manufacture cost and yield of the product increase remarkably, and the mass producibility is very low.

### SUMMARY

An object of the present disclosure is to provide a rubber frame, a backlight module and a display device, so as to improve the assembling of a one-piece rubber frame due to a low structural strength of an avoidance structure.

In one aspect, the present disclosure provides in some embodiments a rubber frame for supporting a cover plate at a light-exiting side of a display panel. A flexible printed circuit board is coupled to a binding end of the display panel, the rubber frame includes an annular frame body, the annular frame body includes a first portion corresponding to the flexible printed circuit board, and the first portion is separated from the other portions of the annular frame body.

In a possible embodiment of the present disclosure, the annular frame body includes a first border corresponding to the binding end of the display panel, and at least a part of the first border is the first portion.

In a possible embodiment of the present disclosure, the first border includes the first portion in the middle and second portions at both ends of the first portion along an extension direction of the first border.

In a possible embodiment of the present disclosure, two opposite ends of the first portion are coupled to the second portions respectively in a snap-fit manner along the extension direction of the first border.

In a possible embodiment of the present disclosure, the first portion is provided with a first boss at each of the two opposite ends, and the corresponding second portion is provided with a first groove for receiving the first boss.

In a possible embodiment of the present disclosure, a gap E between a first side surface of the first boss and a first side wall of the corresponding first groove in a direction perpendicular to the extension direction of the first border is calculated through

$$E = \sqrt{{{A}_{tolerance}}^{2} + {{B}_{tolerance}}^{2} + {{C}_{tolerance}}^{2} + {{D}_{tolerance}}^{2}} ,$$

where A_{tolerance} is a tolerance of a distance from a side of the first border adjacent to the first side wall to the first side wall, B_{tolerance} is a tolerance of a width of the first groove in the direction perpendicular to the extension direction of the first border, C_{tolerance} is a tolerance of a distance from a side of the first portion adjacent to the first side surface to the first side surface, and D_{tolerance} is a tolerance of a width of the first boss in the direction perpendicular to the extension direction of the first border.

In a possible embodiment of the present disclosure, the gap E between the first side surface of the first boss and the first side wall of the corresponding first groove is 0.18 mm to 0.22 mm.

In a possible embodiment of the present disclosure, a surface of the annular frame body coupled to the display panel is provided with a slot for receiving a shock-absorbing material.

In another aspect, the present disclosure provides in some embodiments a backlight module including the above-mentioned rubber frame.

In a possible embodiment of the present disclosure, the backlight module further includes a back plate, the rubber frame surrounds the back plate, the back plate includes a first side plate corresponding to the first portion, and the first side plate is provided with a first connection portion coupled to the first portion in a snap-fit manner.

In a possible embodiment of the present disclosure, the annular frame body includes a first border corresponding to the binding end of the display panel, and the first border includes the first portion in the middle and second portions at two ends of the first portion along the extension direction of the first border. The first connection portion is provided with a second groove, and the first portion is provided with a second boss capable of being inserted into the second groove. The first portion is provided with a first boss at each of the two opposite ends, and the corresponding second portion is provided with a first groove for receiving the first boss.

In a possible embodiment of the present disclosure, a gap G between the second boss and a corresponding side wall of the second groove is the same as a gap E between a first side surface of the first boss and a corresponding first side wall of the first groove in the extension direction of the first border.

In a possible embodiment of the present disclosure, a distance F between the first boss and the first groove in the extension direction of the first border is calculated through F=\sqrt{I_{tolerance}²+J_{tolerance}²+G²}, where I_{tolerance} is a tolerance of a distance between a bottom of the first groove and a bottom of the second groove in the extension direction of the first border, J_{tolerance} is a tolerance of a distance between a first end surface of the first boss away from the second boss and a second end surface of the second boss away from the first boss in the extension direction of the first border, and G is the gap between the second boss and the corresponding side wall of the second groove in the extension direction of the first border.

In yet another aspect, the present disclosure provides in some embodiments a display device including the above-mentioned backlight module and a display panel. A flexible printed circuit board is coupled to a binding end of the display panel, and the flexible printed circuit board is bent to be coupled to a main circuit board at a backlight side of the display panel.

In a possible embodiment of the present disclosure, the backlight module further includes a back plate including a first side plate corresponding to the first portion, and the first side plate is provided with a first connection portion coupled to the first portion in a snap-fit manner. The flexible printed circuit board is provided with a via-hole through which the first connection portion passes when the flexible printed circuit board is bent.

The present disclosure has the following beneficial effects. The first portion corresponding to the flexible printed circuit board is provided separately to ensure the overall strength, and during the assembling, the first portion is coupled to the other portions of the rubber frame after the flexible printed circuit board has been bent. As a result, it is able to reduce the difficulty in the assembling, thereby to prevent the occurrence of light leakage when the flexible circuit board is bent to be in contact with the rubber frame.

### BRIEF DESCRIPTION OF THE DRAWINGS

FIG. 1 is an exploded view of a rubber frame according to one embodiment of the present disclosure;

FIG. 2 a schematic view showing a second portion according to one embodiment of the present disclosure;

FIG. 3 is a schematic view showing a situation where a first boss is coupled to a first groove according to one embodiment of the present disclosure:

FIG. 4 is a schematic view showing a situation where a second boss is coupled to a second groove according to one embodiment of the present disclosure; and

FIG. 5 is a schematic view showing a backlight module according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

In the embodiments of the present disclosure, it should be appreciated that, such words as “in the middle of”, “on/above”, “under/below”, “left”, “right”, “vertical”, “horizontal”, “inside” and “outside” may be used to indicate directions or positions as viewed in the drawings, and they are merely used to facilitate the description in the present disclosure, rather than to indicate or imply that a device or member must be arranged or operated at a specific position. In addition, such words as “first”. “second” and “third” may be merely used to differentiate different components rather than to indicate or imply any importance.

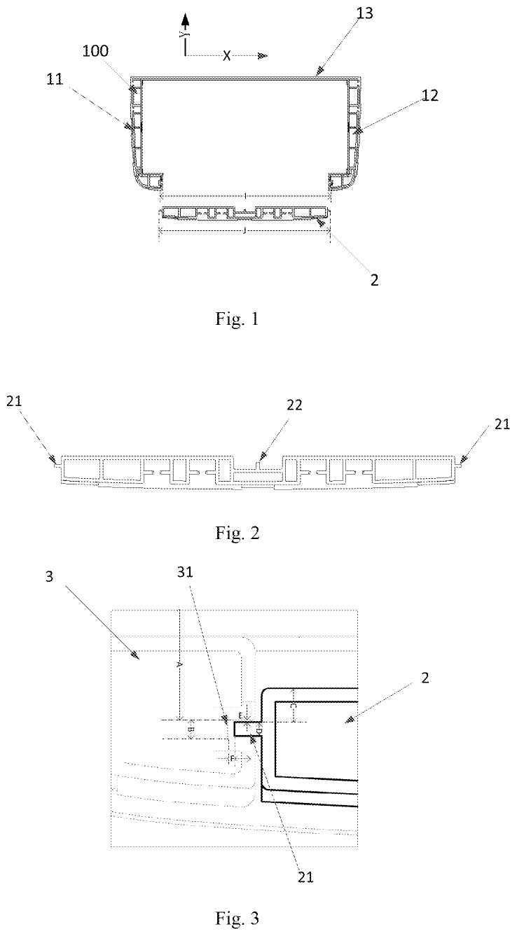

With reference to FIGS. 1 to 5, the present embodiment provides in some embodiments a rubber frame for supporting a cover plate at a light-exiting side of a display panel. A flexible printed circuit board 5 is coupled to a binding end of the display panel, the rubber frame includes an annular frame body 1, the annular frame body 1 includes a first portion 2 corresponding to the flexible printed circuit board 5, and the first portion 2 is separated from the other portions of the annular frame body 1.

Based on the above, a display screen is automatically assembled with a backlight module through a machine, and then the FPC board is bend and fixed manually. The FPC board is attached in accordance with marks on a back plate 4 so as to control a bending radius. Finally, the first portion 2 is positioned and assembled. A sufficient distance is reserved between the first portion 2 and the back plate 4 at an FPC bending region, so as to prevent the first portion 2 from being in direct contact with the FPC bending region, thereby to prevent the occurrence of L0 light leakage when the FPC board is pressed. In this regard, it is able to ensure the strength of the rubber frame, reduce the difficulty in the assembling, overcome the drawbacks caused by the one-piece rubber frame, and remarkably increase the mass producibility without any limitation on an attachment process.

Illustratively, the annular frame body 1 includes a first border corresponding to the binding end of the display panel, and at least a part of the first border is the first portion 2.

A length of the first portion 2 is determined in accordance with a width of a bending region of the flexible printed circuit board 5. The length of the first portion 2 may be slightly greater than the width of the bending region of the flexible printed circuit board 5, i.e., a part of; or the entire of, the first border is selected as the first portion 2.

Illustratively, in a direction of extension of the first border (direction X in FIG. 1), the first border includes the first portion 2 in the middle and second portions 3 at both ends of the first portion 2.

It should be appreciated that, a specific position of the first portion 2 corresponds to a position of the bending region of the flexible printed circuit board 5.

The first portion 2 is coupled to the other portions of the annular frame body 1 in various ways, as long as the first portion 2 is detachably coupled to the other portions of the annular frame body 1. For example, along the extension direction of the first border, the two opposite ends of the first portion 2 are coupled to the corresponding second portions 3 respectively in a snap-fit manner.

Illustratively, the first portion 2 is provided with a first boss 21 at each of the two opposite ends, and the corresponding second portion 3 is provided with a first groove 31 for receiving the first boss 21.

The two second portions 3 at both sides of the first portion 2 are defined as a first sub-portion and a second sub-portion respectively, and the first groove 31 is formed when a local part of the first sub-portion adjacent to an end surface of the second sub-portion is recessed in a direction away from the first portion 2. The first groove 31 in the second sub-portion has a same structure as the first groove 31 in the first sub-portion.

The first bosses 21 at the two ends of the first portion 2 are symmetrically arranged with a middle point of the first portion 2 as a center, so as to ensure that a uniform stress is applied to the first portion 2. At this time, an orthogonal projection of the first groove 31 in the first sub-portion onto the second sub-portion coincides with the first groove 31 in the sub-portion.

In a possible embodiment of the present disclosure, the second portion 3 includes a first surface coupled to the display panel. For ease of assembling, the first groove 31 penetrates through the first surface, so that the first boss 21 is pressed down when it is aligned with the corresponding first groove 31.

In a possible embodiment of the present disclosure, the first groove 31 penetrates through the first sub-portion in a thickness direction of the rubber frame, so as to facilitate the coupling of the first boss 21 to the first groove 31 in a snap-fit manner.

With reference to FIG. 3, for example, in a direction perpendicular to the extension direction of the first border (direction Y in FIG. 1), a gap E between a first side face of the first boss 21 and a corresponding first side wall of the first groove 31 is calculated through

$$E = \sqrt{{{A}_{tolerance}}^{2} + {{B}_{tolerance}}^{2} + {{C}_{tolerance}}^{2} + {{D}_{tolerance}}^{2}} ,$$

wherein A_{tolerance} is a tolerance of a distance between a side of the first border adjacent to the first side wall and the first side wall. B_{tolerance} is a tolerance of a width of the first groove 31 in the direction perpendicular to the extension direction of the first border, C_{tolerance} is a tolerance of a distance between a side of the first portion 2 adjacent to the first side surface and the first side surface, and D_{tolerance} is a tolerance of a width of the first boss 21 in the direction perpendicular to the extension direction of the first border.

Illustratively, A_{tolerance} is ±0.1 mm, B is ±0.1 mm to ±0.08 mm, C_{tolerance} is ±0.1 mm, and D_{tolerance} is ±0.1 mm to ±0.08 mm, so

$$E = \sqrt{{{A}_{tolerance}}^{2} + {{B}_{tolerance}}^{2} + {{C}_{tolerance}}^{2} + {{D}_{tolerance}}^{2}} = \sqrt{{0.1}^{2} + {0.08}^{2} + {0.1}^{2} + {0.08}^{2}} \approx \pm 0.18 .$$

Illustratively, the gap E between the first side surface of the first boss 21 and the corresponding first side wall of the first groove 31 is 0.18 mm to 0.22 mm.

In a possible embodiment of the present disclosure, the gap E between the first side surface of the first boss 21 and the corresponding first side wall of the first groove 31 is, but not limited to, 0.2 mm. E=(B−D)/2, so in the direction perpendicular to the extension direction of the first border, a width B of the first groove 31 and a width D of the first boss 21 need to satisfy B=D+0.4 mm.

Illustratively, a surface of the annular frame body 1 coupled to the display panel is provided with a slot 100 for receiving a shock-absorbing material.

The shock-absorbing material may be, but not limited to, a shock-absorbing adhesive tape.

It should be appreciated that, the number, shapes and sizes of the slots 100 may be set according to the practical needs, and the shapes and sizes of the slots 100 in the annular frame body 1 may be the same or different.

It should be appreciated that, the annular frame body 1 may have a regular or irregular shape. For example, the annular frame body 1 includes a second border 11 and a third border 12 adjacent to the first border, a portion where the second border 11 is coupled to the first border is chamfered, and a portion where the third border 12 is coupled to the first border is chamfered.

Illustratively, a width of the second border 11 in the direction perpendicular to the extension direction of the second border 11 gradually decreases toward a direction close to the first border.

Illustratively, a shape of the second border 11 is the same as a shape of the third border 12.

Illustratively, the annular frame body further includes a fourth border 13 arranged opposite to the first border, and a width of the fourth border 13 is smaller than the width of the second border 11.

Referring to FIG. 5, the present disclosure further provides in some embodiments a backlight module including the above-mentioned rubber frame.

For example, the backlight module further includes a back plate 4, the rubber frame surrounds the back plate 4, the back plate 4 includes a first side plate corresponding to the first portion 2, and the first side plate is provided with a first connection portion 41 coupled to the first portion 2 in a snap-fit manner.

The first portion 2 is coupled to the back plate 4 in the middle, and the two ends of the first portion 2 are coupled to the corresponding second portions 3 respectively. In this way, it is able to fix the first portion 2, thereby to facilitate the assembling.

For example, a second groove 411 is provided in the first connection portion 41, and the first portion 2 is provided with a second boss 22 capable of being inserted into the second groove 411. The first portion 2 is provided with a first boss 21 at each of the two opposite ends, and the corresponding second portion 3 is provided with a first groove 31 for receiving the first boss 21.

The first groove 31 is used to stop the first portion 2 in the direction perpendicular to the extension direction of the first border, and the second groove 411 structure is used to stop the first portion 2 in a direction parallel to the extension direction of the first border. Apart from the first boss 21 and the second boss 22, the other parts of the first portion are depressed to be not in direct contact with the other portions of the annular frame body 1. Based on the above, an assembling position of the first portion 2 is accurately defined, so as to improve the assembling. In addition, it is able to remarkably increase the assembling feasibility and enable an operator to easily perform the assembling through alignment (i.e., aligning the first bosses 21 with the first grooves 31 respectively, and aligning the second bosses 22 with the second grooves 411 respectively), thereby to prevent the rubber frame from being broken. Further, the first portion 2 is not in direct contact with the other portions of the annular frame body 1, so it is able to prevent the rubber frame from being deformed during the assembling, thereby to improve the yield of the product.

Illustratively, the first connection portion 41 protrudes in a direction close to the first portion 2, a middle part of the second portion 2 is recessed to form a third groove, and a part of a bottom of the third groove protrudes in a direction close to the first connection portion 41 to form the second boss 22. A length of the second boss 22 is smaller than or equal to a depth of the third groove in the direction perpendicular to the extension direction of the first border.

It should be appreciated that, in the direction perpendicular to the extension direction of the first border, the length of the second boss 22 may also be greater than the depth of the third groove. The depth of the third groove may be set according to the practical needs, and a gap between the second portion and the back plate may be adjusted through adjusting the depth of the third groove (namely, adjusting a bending space for accommodating the flexible printed circuit board). In a possible embodiment of the present disclosure, a surface of the second portion adjacent to the back plate is a plane.

Illustratively, in the extension direction of the first border, a gap G between the second boss 22 and the corresponding side wall of the second groove 411 is the same as a gap E between the first side surface of the first boss 21 and the corresponding first side wall of the first groove 31.

In other words, the gap G between the second boss 22 and the corresponding side wall of the second groove 411 may be, but not limited to, 0.2 mm.

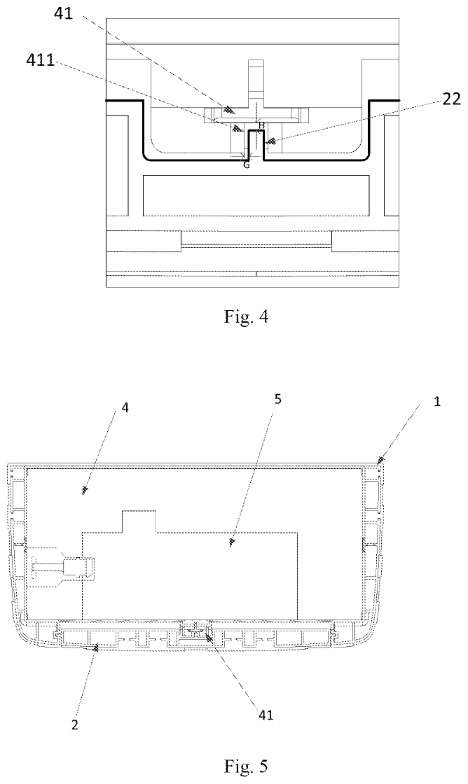

Referring to FIGS. 3 and 4, a distance F between the first boss 21 and the first groove 31 in the extension direction of the first border is calculated through F=\sqrt{I_{tolerance}²+J_{tolerance}²+G²}, where I_{tolerance} is a tolerance of a distance between the bottom of the first groove 31 and a bottom of the second groove 411 in the extension direction of the first border, J_{tolerance} is a tolerance of a distance between a first end surface of the first boss 21 away from the second boss 22 and a second end surface of the second boss 22 away from the first boss 21 in the extension direction of the first border, and G is the gap between the second boss 22 and a corresponding side wall of the second groove 411 in the extension direction of the first border.

The value of G may refer to the value of E, and in a possible embodiment of the present disclosure, G is, but not limited to, 0.2 mm.

Illustratively, I_{tolerance} is ±0.2 mm and J_{tolerance} is ±0.2 mm, so F=\sqrt{I_{tolerance}²+J_{tolerance}²+G²}=\sqrt{0.2²+0.2²+0.2²}≈±0.35. In a possible embodiment of the present disclosure, F is, but not limited to, 0.4 mm to 0.5 mm.

It should be appreciated that, a distance H between the bottom of the second groove 411 and the end surface of the second boss 22 adjacent to one end of the second groove 411 may refer to the value of F. For example, H is, but not limited to, 0.4 mm to 0.5 mm.

It should be appreciated that, the first bosses 21 are symmetrically arranged with respect to the second boss 22, i.e., the first bosses 21 are arranged at two sides of the second bosses 22 respectively, so as to apply a uniform stress to the first portion 2.

The present disclosure further provides in some embodiments a display device, including the above-mentioned backlight module and a display panel. A flexible printed circuit board 5 is coupled to a binding end of the display panel, and the flexible printed circuit board 5 is bent to be coupled to a main circuit board at a backlight side of the display panel.

For example, the back plate 4 includes a first side plate corresponding to the first portion 2, and the first side plate is provided with a first connection portion 41 coupled to the first portion 2 in a snap-fit manner. The flexible printed circuit board 5 is provided with a via-hole through which the first connection portion 41 passes when the flexible printed circuit board 5 is bent.

The via-hole is formed in a non-wiring region of the flexible printed circuit board 5, so as to prevent the flexible circuit board 5 from being adversely affected while fixing the first portion 2.

For example, the rubber frame is fixed to the cover plate through VHB glue. During the assembling, the portions of the annular frame body 1 other than the first portion 2 are fixed to the cover plate through the VHB glue. After the flexible printed circuit board has been bent and fixed, the first portion 2 is assembled. Finally, the second portion is fixed to the cover plate through the VHB glue. The VHB glue has an excellent adhesive effect and does not fall off during the assembling. In addition, it is able to perform the above-mentioned fixation simply.

The display device may be any product or member having a display function, e.g., liquid crystal television, liquid crystal display, digital photo frame, mobile phone or tablet computer. The display device further includes a flexible circuit board, a printed circuit board and a back plate 4.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A rubber frame for supporting a cover plate at a light-exiting side of a display panel, wherein a flexible printed circuit board is coupled to a binding end of the display panel, the rubber frame comprises an annular frame body, the annular frame body comprises a first portion corresponding to the flexible printed circuit board, and the first portion is separated from the other portions of the annular frame body.

2. The rubber frame according to claim 1, wherein the annular frame body comprises a first border corresponding to the binding end of the display panel, and at least a part of the first border is the first portion.

3. The rubber frame according to claim 2, wherein the first border comprises the first portion in the middle and second portions at both ends of the first portion along an extension direction of the first border.

4. The rubber frame according to claim 3, wherein two opposite ends of the first portion are coupled to the second portions respectively in a snap-fit manner along the extension direction of the first border.

5. The rubber frame according to claim 3, wherein the first portion is provided with a first boss at each of the two opposite ends, and the corresponding second portion is provided with a first groove for receiving the first boss.

6. The rubber frame according to claim 5, wherein a gap E between a first side surface of the first boss and a first side wall of the corresponding first groove in a direction perpendicular to the extension direction of the first border is calculated through
$$E = \sqrt{{{A}_{tolerance}}^{2} + {{B}_{tolerance}}^{2} + {{C}_{tolerance}}^{2} + {{D}_{tolerance}}^{2}} ,$$
where A_{tolerance} is a tolerance of a distance from a side of the first border adjacent to the first side wall to the first side wall, B_{tolerance} is a tolerance of a width of the first groove in the direction perpendicular to the extension direction of the first border, C_{tolerance} is a tolerance of a distance from a side of the first portion adjacent to the first side surface to the first side surface, and D_{tolerance} is a tolerance of a width of the first boss in the direction perpendicular to the extension direction of the first border.

7. The rubber frame according to claim 6, wherein the gap E between the first side surface of the first boss and the first side wall of the corresponding first groove is 0.18 mm to 0.22 mm.

8. The rubber frame according to claim 1, wherein a surface of the annular frame body coupled to the display panel is provided with a slot for receiving a shock-absorbing material.

9. A backlight module, comprising the rubber frame according to claim 1.

10. The backlight module according to claim 9, further comprising a back plate, wherein the rubber frame surrounds the back plate, the back plate comprises a first side plate corresponding to the first portion, and the first side plate is provided with a first connection portion coupled to the first portion in a snap-fit manner.

11. The backlight module according to claim 10, wherein the annular frame body comprises a first border corresponding to the binding end of the display panel, and the first border comprises the first portion in the middle and second portions at two ends of the first portion along the extension direction of the first border;
the first connection portion is provided with a second groove, and the first portion is provided with a second boss capable of being inserted into the second groove; and
the first portion is provided with a first boss at each of the two opposite ends, and the corresponding second portion is provided with a first groove for receiving the first boss.

12. The backlight module according to claim 11, wherein a gap G between the second boss and a corresponding side wall of the second groove is the same as a gap E between a first side surface of the first boss and a corresponding first side wall of the first groove in the extension direction of the first border.

13. The backlight module according to claim 12, wherein a distance F between the first boss and the first groove in the extension direction of the first border is calculated through F=\sqrt{I_{tolerance}²+J_{tolerance}²+G²}, where I_{tolerance} is a tolerance of a distance between a bottom of the first groove and a bottom of the second groove in the extension direction of the first border, J_{tolerance} is a tolerance of a distance between a first end surface of the first boss away from the second boss and a second end surface of the second boss away from the first boss in the extension direction of the first border, and G is the gap between the second boss and the corresponding side wall of the second groove in the extension direction of the first border.

14. A display device, comprising the backlight module according to claim 9 and a display panel, wherein a flexible printed circuit board is coupled to a binding end of the display panel, and the flexible printed circuit board is bent to be coupled to a main circuit board at a backlight side of the display panel.

15. The display device according to claim 14, wherein the backlight module further comprises a back plate comprising a first side plate corresponding to the first portion, and the first side plate is provided with a first connection portion coupled to the first portion in a snap-fit manner; and
the flexible printed circuit board is provided with a via-hole through which the first connection portion passes when the flexible printed circuit board is bent.

16. The rubber frame according to claim 1, wherein the annular frame body comprises a second border and a third border adjacent to the first border, a portion where the second border is coupled to the first border is chamfered, and a portion where the third border is coupled to the first border is chamfered.

17. The rubber frame according to claim 16, wherein a width of the second border in a direction perpendicular to the second border increases gradually in a direction close to the first border.

18. The backlight module according to claim 13, wherein the gap G between the second boss and a corresponding side wall of the second groove is 0.2 mm.

19. The backlight module according to claim 13, wherein the distance F between the first boss and the first groove is 0.4 mm to 0.5 mm.

20. The backlight module according to claim 13, wherein the two first bosses are arranged symmetrically with respect to the second boss.
